(19) United States
(12) Patent Application Publication
(10) Pub. No.: US 2026/0006427 A1
(43) Pub. Date: Jan. 1, 2026

(54) SYSTEM AND METHOD FOR CONVERGED NEF-BASED COMMUNICATION

(71) Applicant: JIO PLATFORMS LIMITED, Ahmedabad, Gujarat (IN)

(72) Inventors: Aayush BHATNAGAR, Navi Mumbai, Maharashtra (IN); Hardik Navinbhai BAVISHI, Navi Mumbai, Maharashtra (IN); Sandeep BISHT, Kalyan Thane, Maharashtra (IN); Kumar Gaurav SINGH, Panvel, Marashtra (IN); Nilesh SANAS, Navi Mumbai, Maharashtra (IN); Amit Kumar SINGH, Kalyan East, Maharashtra (IN); Raghvendra BHUSHAN, Dist - Thane, Maharashtra (IN); Mangesh Shantaram KALE, Navi Mumbai, Maharashtra (IN); Gaurav JAIN, Maharashtra (IN); Anurag SINHA, Mumbai, Maharashtra (IN)

(73) Assignee: JIO PLATFORMS LIMITED, Ahmedabad, Gujarat (IN)

(21) Appl. No.: 18/992,910

(22) PCT Filed: May 3, 2024
(86) PCT No.: PCT/IN2024/050478

§ 371 Date: Jan. 9, 2025

(30) Foreign Application Priority Data
May 30, 2023 (IN) 202321037312

(51) Int. Cl. H04W 8/12; H04W 36/00; H04W 36/14

(52) U.S. Cl. CPC H04W 8/12; H04W 36/0066; H04W 36/1443

(57) ABSTRACT

The present disclosure handles Evolved Packet Core (EPC) and 5G Core (5GC) interworking for network exposure scenarios. The present disclosure exposes network capabilities and User Equipment (UE) related information to external Application functions (AF) and to internal Network Functions (NFs). The present disclosure supports monitoring of event exposure of the NFs and expose the events of the NFs to the AF. The present disclosure supports device triggering. The present disclosure supports Non-IP Data Delivery (NIDD) Configuration. Further, the present disclosure supports Mobile Originated (MO), Mobile Terminated (MT) and SM-Context creation. Also, the present disclosure provides a proprietary interface for communication between Network Exposure Function (NEF) and Service Capability Exposure Function (SCEF) while aggregating data from 4G and 5G network.

### RESERVATION OF RIGHTS

A portion of the disclosure of this patent document contains material, which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to converged Network Exposure Function (NEF)-based communication, and specifically to handling Evolved Packet Core (EPC) and 5G Core (5GC) interworking for network exposure scenarios.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

As per 3rd Generation Partnership Project (3GPP) standards, Network Exposure Function (NEF) uses Hypertext Transfer Protocol/2 (Http2) Protocol, but in case of interworking scenarios, the NEF may need to communicate with core nodes which support a diameter interface. The 3GPP standards evolve with time and cover aspects of integration and features that the node supports. However, existing methods lack explicit description of interaction between 4G and 5G nodes like Service Capability Exposure Function (SCEF) and NEF. The 3GPP describes about Application Functions (AFs) interaction with the NEF and the SCEF through a Common Application Programming Interface Framework (CAPIF). However, the description lacks about how the CAPIF selects between the NEF and the SCEF. Moreover, the AF needs to implement both N33 and T8 application programming interfaces (APIs) which may be painstaking.

There is, therefore, a need in the art to improve state of handling Evolved Packet Core (EPC) and 5G Core (5GC) interworking for network exposure scenarios.

### OBJECTS OF THE PRESENT DISCLOSURE

It is an object of the present disclosure to handle Evolved Packet Core (EPC) and 5G Core (5GC) interworking for network exposure scenarios.

It is an object of the present disclosure to expose network capabilities and User Equipment (UE) related information to external Application Functions (AFs) and to internal Network Functions (NFs) (like Network Data Analytics Function (NWDAF)).

It is an object of the present disclosure to support monitoring of event exposure of the NFs and expose the events of the NFs to the AF.

It is an object of the present disclosure to support device triggering.

It is an object of the present disclosure to support Non-IP Data Delivery (NIDD) configuration.

It is an object of the present disclosure to support Mobile Originated (MO), Mobile Terminated (MT), and Session Management (SM)-Context creation.

It is an object of the present disclosure to provide an interface for communication between Network Exposure Function (NEF) and Service Capability Exposure Function (SCEF) while aggregating data from 4G and 5G network.

It is an object of the present disclosure to reduce NEF/SCEF dependency on Access and Mobility Function (AMF) and Mobility Management Entity (MME) communication for interworking scenarios.

### SUMMARY

The present disclosure discloses a system for handling interworking communication between an Evolved Packet Core (EPC) and a 5G Core (5GC). The system includes a receiving node and an interworking node. The receiving node is configured to generate at least one request for fetching at least one network related information and at least one user equipment related information from the EPC and the 5GC. The interworking node is coupled to the receiving node to receive the generated at least one request from the receiving node. The interworking node includes a network exposure function (NEF) and a service capability exposure function (SCEF). The interworking node is configured to process the received request. The interworking node is further configured to connect the receiving node to a specific network element. The interworking node is further configured to enable at least one service in the EPC and the 5GC.

In an embodiment, the system further includes a NEF application (102), a NEF database (DB), a common application programming interface framework (CAPIF), a NEF manager, an elastic load balancer (ELB), a SCEF application, a SCEF-supplementary downlink (SDL), a SCEF-ELB, and a SCEF-operations, administration, and maintenance (OAM).

In an embodiment, the receiving node is an application function (AF), an application server (AS), and a network function.

In an embodiment, the NEF and the SCEF are connected via a NeSC interface.

In an embodiment, the NeSc interface is configured to employ a second version of the Hypertext Transfer Protocol (HTTP2) protocol.

In an embodiment, the NeSc interface is configured to provide a point of contact to the receiving node irrespective of user equipment being in the EPC or the 5GC.

In an embodiment, the at least one service is selected from a group consisting of monitoring of event, device triggering, non-IP data delivery (NIDD) configuration, mobile originated messages (MO)-context creation, mobile terminate message (MT)-context creation, and session management (SM)-context creation.

In an embodiment, the specific network element is selected from a group consisting of access and mobility management function (AMF), session management function (SMF), unified data management (UDM), binding support function (BSF), network data analytics function (NWDAF), mobility management entity (MME), home subscriber server (HSS), policy and charging rules function (PCRF), short message service center (SMSC), service control point (SCP), SMS function (SMSF), IP short message (IPSM), SMS service center (SMS-SC).

In an embodiment, the NEF manager (108) is configured to communicate with an element management system (EMS) that provides performance management, fault management, backup, and restoration of configuration.

In an embodiment, the NEF database (DB) includes 3 master databases, 3 slave databases, and 1 replication database.

The present disclosure discloses a method for handling interworking communication between an Evolved Packet Core (EPC) and a 5G Core (5GC). The method includes receiving, by an interworking node, a request from a receiving node. The interworking node includes a network exposure function (NEF) and a service capability exposure function (SCEF). The method includes processing, by the interworking node, the received request. The method includes connecting, by the interworking node, the receiving node to a specific network element. The method includes enabling, by the interworking node, at least one service in the EPC and the 5GC.

In an embodiment, the receiving node is an application function (AF), an application server (AS), and a network function.

In an embodiment, the specific network element is selected from a group consisting of access and mobility management function (AMF), session management function (SMF), unified data management (UDM), binding support function (BSF), network data analytics function (NWDAF), mobility management entity (MME), home subscriber server (HSS), policy and charging rules function (PCRF), short message service center (SMSC), service control point (SCP), SMS function (SMSF), IP short message (IPSM), SMS service center (SMS-SC).

In an embodiment, the interworking node is configured to aggregate data from a 4G network and a 5G network.

In an embodiment, the at least one service is selected from a group consisting of monitoring of event, device triggering, non-IP data delivery (NIDD) configuration, mobile originated messages (MO)-context creation, mobile terminate message (MT)-context creation, and session management (SM)-context creation.

The present disclosure discloses a converged network exposure function (NEF) for handling interworking communication between an Evolved Packet Core (EPC) and a 5G Core (5GC). The converged network exposure function (NEF) includes a network exposure function (NEF), a service capability exposure function (SCEF), and a processing unit. The processing unit is configured to receive at least one request from an application function (AF) for fetching at least one network related information and at least one user equipment related information from the EPC and the 5GC The processing unit is configured to process the received request The processing unit is configured to connect the receiving node to a specific network element The processing unit is configured to enable at least one service in the EPC and the 5GC.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1A illustrates exemplary functional elements of a system for handling interworking communication between an Evolved Packet Core (EPC) and a 5G Core (5GC), in accordance with an embodiment of the present disclosure.

FIG. 1B illustrates exemplary internal components of the system, in accordance with an embodiment of the present disclosure.

FIG. 2 illustrates an exemplary flow mechanism of interaction of an application server (AS) with the system, in accordance with an embodiment of the present disclosure.

FIG. 3 illustrates an exemplary architecture of the system, in accordance with an embodiment of the present disclosure.

FIG. 4 illustrates is an illustration of a non-limiting example of details of computing hardware used in the system, in accordance with an embodiment of the present disclosure.

FIG. 5 illustrates an exemplary flow mechanism of creating monitoring event by the system, in accordance with an embodiment of the present disclosure.

FIG. 6 illustrates an exemplary flow mechanism of non-IP data delivery (NIDD) configuration by the system, in accordance with an embodiment of the present disclosure.

FIG. 7 illustrates an exemplary flow mechanism for session management (SM)-context creation by the system, in accordance with an embodiment of the present disclosure.

FIG. 8 illustrates an exemplary flow mechanism for mobile originated messages (MO)-context creation by the system, in accordance with an embodiment of the present disclosure.

FIG. 9 illustrates an exemplary flow mechanism for mobile terminate message (MT)-context creation by the system, in accordance with an embodiment of the present disclosure.

FIG. 10 illustrates an exemplary flow mechanism for device triggering by the system, in accordance with an embodiment of the present disclosure.

### LIST OF REFERENCE NUMERALS

100—System
102—Network Exposure Function (NEF) Application
104—NEF Database
106, 304—Common Application Programming Interface Framework (CAPIF)
108—NEF Manager
110—Elastic Load Balancer (ELB)
112—Service Capability Exposure Function (SCEF) Application
114—SCEF-Supplementary Downlink (SDL)
116—SCEF-ELB
118—Operations, Administration, and Maintenance (OAM)
120—Service Capability Server (SCS)/Application Server (AS)
122—Evolved Packet Core (EPC)
124—CAPIF Programmable, Open, and Disaggregated Solution (POD)
126—NEF-POD
128, 310—Service Communication Proxy (SCP)
130—Network Repository Function (NRF)
150—Receiving Node
170—Interworking Node
204—4G nodes
206—5G nodes
208—Converged NEF
302—Application Server
306—Database
308—SCEF
312—Diameter Routing Agent (DRA)
314—HA state module
410—External Storage Device
420—Bus
430—Main Memory
440—Read Only Memory
450—Mass Storage Device
460—Communication Port
470—Processor

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

At present, 3GPP teaches a little about integration and feature-related aspects supported by network nodes. The absence of a clear depiction of the interaction between 4G and 5G nodes, such as network exposure function (NEF) and a service capability exposure function (SCEF), generates a complex architecture. The present disclosure discloses a method and a system using a NeSC interface. According to 3GPP standards, NEF utilizes the HTTP/2 protocol. However, in interworking scenarios, NEF need to communicate with core nodes that support the Diameter interface.

The present disclosure establishes an interface between SCEF and NEF, referred to as the NeSC interface. The NeSC interface utilizes the existing HTTP/2 protocol, providing the necessary functionalities exposed by the present system.

The present disclosure discloses a system for handling interworking communication between an Evolved Packet Core (EPC) and a 5G Core (5GC) that includes an interworking unit. In an example, the network may be a 4G network or a 5G network. The interworking unit is configured to allow exchange of request messages between 4G and 5G nodes such as Service Capability Exposure Function (SCEF) and Network Exposure Function (NEF). The interworking unit (also known as converged Network Exposure Function) is configured to convert the request message from one node into a format that is compatible with the other node.

The present disclosure provides a system and a method that handles interworking between Evolved Packet Core (EPC) and 5G core (5GC) in network exposure scenarios. The present disclosure provides a system and a method that enables designing of flows and interfaces between 4G and 5G nodes such as SCEF and NEF. The present disclosure provides a system and a method that supports use of N33 and T8 application programming interfaces (APIs) by application functions (AFs).

The converged Network Exposure Function (NEF) is a combination of Service Capability Exposure Function (SCEF) and NEF. This combination makes the converged NEF to expose network capabilities of 4G as well as 5G core. The converged NEF exposes network capabilities and User Equipment (UE) related information to external application functions and to some internal Network Functions (NFs) (like Network Data Analytics Function (NWDAF)). The present disclosure enables the converged NEF to support following prime functionalities:
Supports monitoring of event exposure of NFs and expose the events to an application function (AF),
Supports device triggering,
Supports Non-IP Data Delivery (NIDD) configuration, and
Supports Mobile Originated (MO) message, Mobile Terminated (MT) message, and Session Management (SM)-Context creation.

The proposed disclosure provides a proprietary interface (NeSC), which is used for communication between the NEF and the SCEF while aggregating data from 4G and 5G network. This interface provides single point of contact to the AF irrespective of a UE being in 4G core of 5G core. The interface reduces NEF/SCEF dependency on Access and Mobility Management Function (AMF)-Mobility Management Entity (MME) communication (N26 interface) for interworking scenarios.

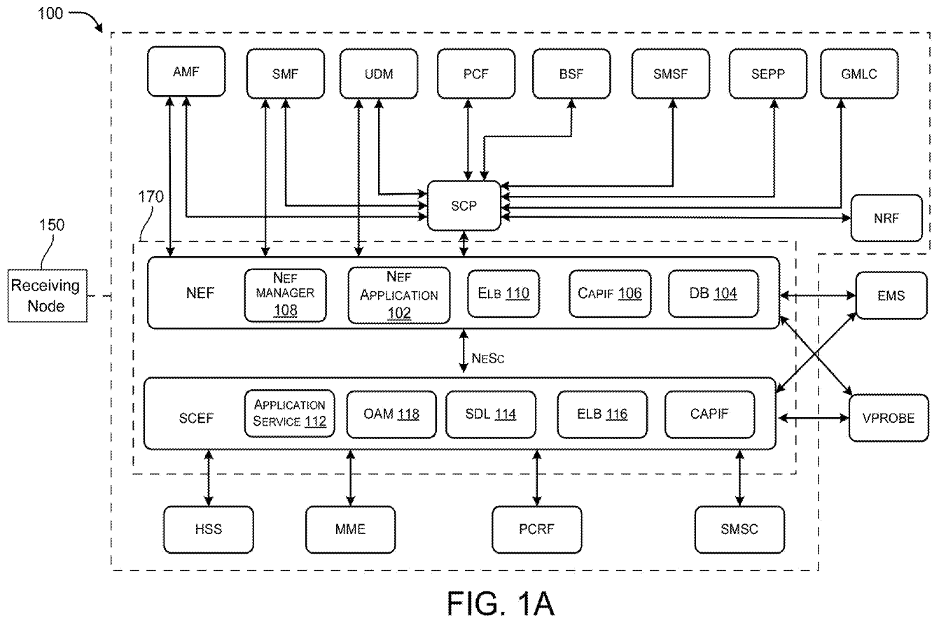

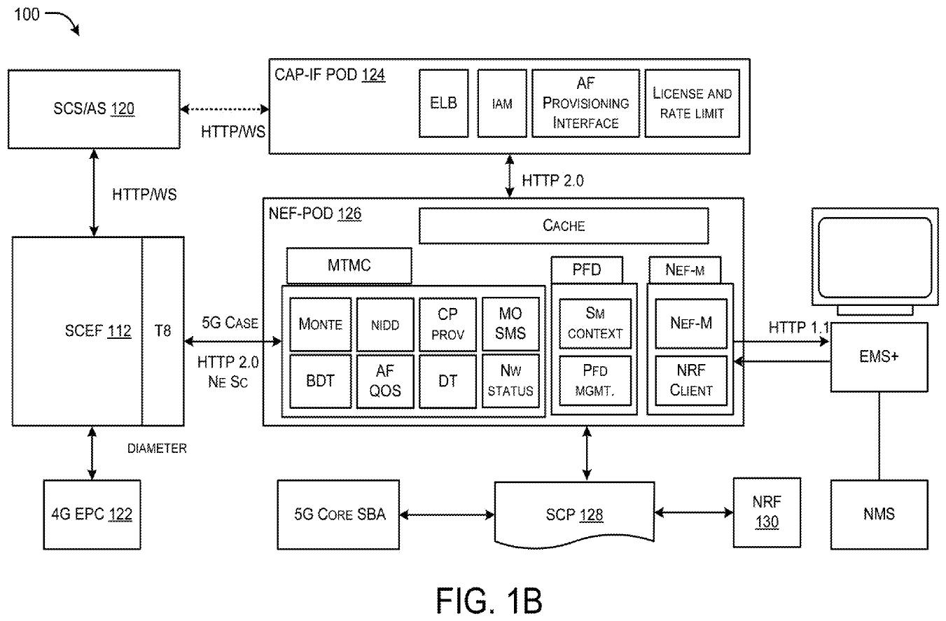

The various embodiments throughout the disclosure will be explained in more detail with reference to FIG. 1A-FIG. 10.

FIG. 1A illustrates exemplary functional elements of a system (100), in accordance with an embodiment of the present disclosure. In an embodiment, and as shown in FIG. 1, the system (100) includes include a NEF application (102), a NEF Database (DB) (104), a Common Application Programming Interface Framework (CAPIF) (106), a NEF manager (108), an Elastic Load Balancer (ELB) (110), a SCEF application (112), a SCEF-Supplementary Downlink (SDL) (114), a SCEF-ELB (116), and a SCEF-Operations, Administration, and Maintenance (OAM) (118).

The system includes a receiving node and an interworking node. The receiving node is configured to generate at least one request for fetching at least one network related information and at least one user equipment related information from the EPC and the 5GC. For example, the receiving node is an application function (AF), an application server (AS), and a network function. The interworking node is coupled to the receiving node to receive the generated at least one request from the receiving node. The interworking node includes a network exposure function (NEF) and a service capability exposure function (SCEF). The interworking node is configured to receive, by an interworking node, a request from a receiving node. The interworking node includes a network exposure function (NEF) and a service capability exposure function (SCEF). The interworking node is configured to process the received request. The interworking node is further configured to connect the receiving node to a specific network element. In an example, the specific network element is selected from a group having access and mobility management function (AMF), session management function (SMF), unified data management (UDM), binding support function (BSF), network data analytics function (NWDAF), mobility management entity (MME), home subscriber server (HSS), policy and charging rules function (PCRF), short message service center (SMSC), service control point (SCP), SMS function (SMSF), IP short message (IPSM), SMS service center (SMS-SC). The interworking node is further configured to enable at least one service in the EPC and the 5GC. The at least one service is selected from a group consisting of monitoring of event, device triggering, non-IP data delivery (NIDD) configuration, mobile originated messages (MO)-context creation, mobile terminate message (MT)-context creation, and session management (SM)-context creation. Furthermore, the converged NEF is a combination of the SCEF and the NEF. This combination makes converged NEF to expose network capabilities of 4G as well as 5G core. In an embodiment, the system (converged NEF) (100) includes NEF under 5G core and SCEF under 4G core. A NeSC interface is used for communication between the NEF and the SCEF while aggregating data from 4G and 5G network. In an example, the NEF and the SCEF are connected via a NeSC interface. The NeSc interface is configured to employ a second version of the Hypertext Transfer Protocol (HTTP2) protocol. The NeSc interface is configured to provide a point of contact to the receiving node irrespective of user equipment being in the EPC or the 5GC.

The system (100) supports interworking scenarios where the user equipment (UE) roams between 4G and 5G core. Hence, the interworking node (converged NEF) acts as a single point of contact to application function for fetching network and UE related information from 4G and 5G cores. In an example embodiment, the converged NEF supports services for 4G, 5G, and interworking such as, but not limited to, monitoring event exposure, device trigger, NIDD configuration, or the like.

In an embodiment, the NEF application (102) is similar to an SCEF application in Long-Term Evolution (LTE). The NEF application (102) facilitates secure, robust, developer-friendly access to exposed network services and capabilities. This access is provided by a set of northbound RESTful APIs from a network domain to both internal and external applications. The NEF application (102) interacts with 5G core elements (network elements) that include, but not limited to, Access and Mobility Management Function (AMF), Session Management Function (SMF), Unified Data Management (UDM), Binding Support Function (BSF), and Network Data Analytics Function (NWDAF), and aggregated data from these nodes for further exposure to external AFs (over N33 interface) or internal NFs. A scenario to utilize this service can be related to a MEC AF that informs the 5G network that the subscriber has just launched a gaming app, with instructions for the 5G network to send gaming traffic to local MEC resources.

In an embodiment, the SCEF is capable of exposing network capabilities of 4G core. The SCEF holds the DIAMETER interface modules, Hypertext Transfer Protocol (HTTP) client and server modules (for T8), SDL client, OAM client, replication, and clustering module, SCEF core logic, and in-memory cache. The SCEF interacts with 4G core elements that include, but not limited to, Mobility Management Entity (MME), Home Subscriber Server (HSS), Policy and Charging Rules Function (PCRF), and Short Message Service Centre (SMSC), and aggregated data from these nodes for further exposure to external AFs (over T8 interface) or internal NFs. However, in case of system (100), the SCEF does not directly interact with AF. The SCEF uses NeSC interface to communicate with the NEF. The NEF propagates messages to AF over N33 interface.

In an embodiment, an AF sends the requests to influence SMF routing decisions for user plane traffic of Protocol Data Unit (PDU) sessions by configuring Policy and Charging Control (PCC) rules. The PCC rules include, but not limited to, a Data Network Name (DNN), a Network Slice Selection Assistance Information (NSSAI), a traffic identifier, a User Equipment (UE) Identifier (ID), and the like. The PCC rules are created on basis of local routing indication from the PDU session policy control subscription information and considering UE location presence in area of interest (i.e., Presence Reporting Area).

In an embodiment, the NEF DB (104) is a database of events and service data related to all the subscribers. The NEF DB (104) is used for Fault-management, Configuration, Accounting, Performance, and Security (FCAPS) data storage by the NEF manager (108). The data may be read at runtime by the NEF application (102) and the NEF manager (108). The NEF DB (104) includes a plurality of NEF-DBs. In an example, the NEF database (DB) (104) includes 3 master databases, 3 slave databases, and 1 replication database.

In an embodiment, the CAPIF (106) has a unified north bound API framework across several 3GPP functions. The CAPIF (106) is responsible for authentication and authorization of the AFs. The CAPIF (106) provides an OAUTH token to external AF and provides AFs root CA certificate to the NEF for AF verification and TLS establishment.

In an embodiment, the NEF ELB (110) is used as a point of contact for the external AFs. The ELB (110) is used as a load balancer to forward the messages from the AF to the CAPIFs (106) (for authentication and authorization) and application servers on round-robin basis. Active ELBs is responsible for receiving the requests from the AFs to be forwarded to the CAPIF (106) and application nodes. Standby ELBs handle the requests in case of failure with the active ones.

In an embodiment, the NEF manager (108) is an operations and management micro-service responsible for FCAP management of the application and interacting with the EMS. The NEF manager (108) is responsible for NEF registration with the NRF. The NEF manager (108) is configured to communicate with an element management system (EMS) that provides performance management, fault management, backup, and restoration of configuration.

In an embodiment, SCEF application (112), i.e., application service CNFC holds DIAMETER interface modules, HTTP client and server modules (for T8), SDL client, OAM client, replication, and clustering module, SCEF core logic, and in-memory cache. The SCEF application (112) supports following features with 4G core:
a) Non-IP Data Delivery (NIDD): The SCEF supports NIDD integration with MME or SGSN using T6a/T6b interfaces based on Diameter. The NIDD handles mobile originated (MO) and mobile terminated (MT) communication with the UE, where the data used for the communication is considered unstructured evolved from 4G/5G packet core standpoint (also known as non-IP). The NIDD feature exposes data to SCS or AS using the 3GPP northbound RESTful APIs. Following are NIDD Procedures:
   1. NIDD Configuration,
   2. SM-Context creation/Deletion (UE Connection establishment/Release),
   3. Mobile Originated messages (MO), and
   4. Mobile Terminate Message (MT).
b) Device Trigger: Device Triggering allows the AF to send information to the UE through a network to trigger the UE to perform application-specific actions that include initiating communication with SCS for the indirect model or an AS in the network for the hybrid model. Device Triggering is required when an IP address for the UE is not available or reachable by AF.
c) Monitoring Events with 4G core: The monitoring events feature monitors specific events in a 3GPP system and makes monitoring event information available using the converged NEF. It identifies the 3GPP network element suitable for configuring specific events, event detection, and event reporting to the authorized users, for example, for use by applications or logging. If such an event is detected, the network is configured to perform special actions, for example, limit UE access.
d) SM Context creation: SM-Context is created by the system on a request received from the SMF or the MME. This SM-context allows the system (NEF) to identify the SCEF instance and also let the NEF to inform the AF about MT UE status and send buffered MT messages to the UE.

SCEF SDL (114) CNFC: The SDL CNFC is used to store the persistent long-lived data (i.e., Monitoring Enhancement (MONTE) and NIDD configuration data, EPS context data, etc.). The application processes and fetches data from the DB (104) as and when required during transaction processing and updates it back to a DB cluster.

SCEF OAM (118) CNFC: The OAM CNFC is used to communicate with the EMS for FCAPS, CNF life-cycle management, and product installation and commissioning.

SCEF-ELB (116) CNFC: The ELB CNFC is used to load balance the HTTP(S) traffic between the SCEF (112) and application servers (SCS/AS). In converged NEF implementation, the ELB (110) is placed on NeSC interface between the SCEF (112) and the NEF (102).

HA State Module (HSM): The HSM is responsible for providing high-availability by coordinating successful switchover between the active and standby nodes in case there is a failure in the active node. Hence, if the active node goes down due to any reason, the standby node takes over the active state and starts handling the traffic. Once the problematic node comes up, it will take the standby state.

In an embodiment, and as shown in FIG. 1B, the system (100) further includes various elements such as the SCEF (112), Service Capability Server (SCS)/Application Server (AS) (120), an Evolved Packet Core (EPC) (122), CAPIF Programmable, Open, and Disaggregated Solution (POD) (124), NEF-POD (126), SCP (128), and NRF (130).

The EPC (122) is formed by multiple nodes, the main ones being the MME and the HSS as shown in FIG. 1A. The nodes offer multiple functionalities like mobility management, authentication, session management, setting up bearers and application of different Quality of Services.

The CAPIF POD (124) includes the ELB, IAM, an AF provisioning interface, and a licence and rate limit. The CAPIF POD (124) communicates with the SCS/AS (120).

The NEF-POD (126) includes Machine-To-Machine-Type Communications (MTMC), Packet Flow Descriptions (PFD), and NEF-M and communicates with the SCEF (112).

The Service Communication Proxy (SCP) (128) is a decentralized solution and composed of control plane and data plane. This solution is deployed along side of Network Functions (NF) for providing routing control, resiliency, and observability to the core network.

The Network Repository Function (NRF) (130) works as a centralized repository for all the NFs in the operator's network. The NRF may allow the NFs to register and discover each other via a standards-based API.

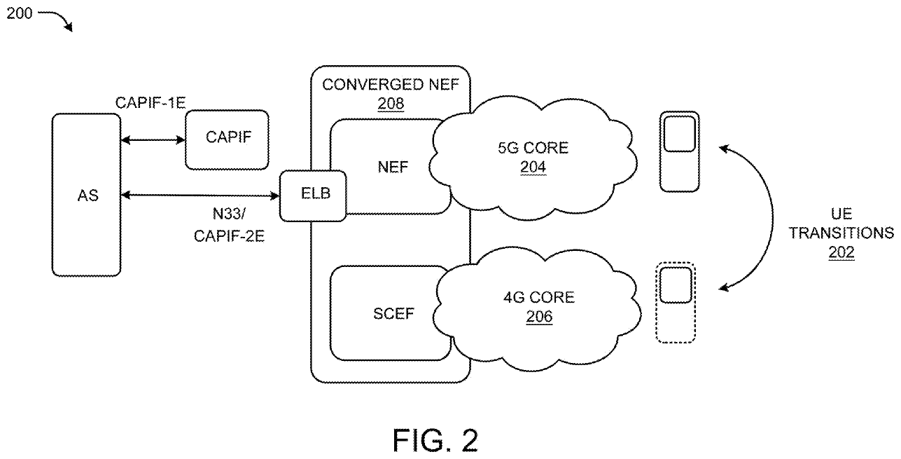

FIG. 2 illustrates an exemplary flow mechanism (200) of an application server interaction with the system, in accordance with an embodiment of the present disclosure.

With respect to FIG. 2, at 202, the UE indicates to AMF for Non-IP connectivity in a PDU session establishment request with “PDN type” as unstructured and uses control plane Cellular Internet of Things (CIoT) 5GS optimization.

In CIoT core that has 4G nodes (204) and 5G nodes (206), the UE has flexibility to inform S1-mode (EPC) or N1-mode (5G) in 5G-MM capability during attach. The CIoT core also steers UE attach in 4G or 5G based on operator policy (e.g., due to roaming agreements, preferred and supported network behaviour, load redistribution). This steering is done by MME or SMF.

In an embodiment, the UE may also indicate support for Relational Database Service (RDS). The RDS is a mechanism for NEF to determine if the data was successfully delivered to the UE and for the UE to determine if the data was successfully delivered to the NEF based on acknowledgements.

The converged NEF (208) acts as a single point of contact for the AF. The AF does not need to care for a UE availability in 4G or 5G or handle separate APIs for the SCEF and the NEF.

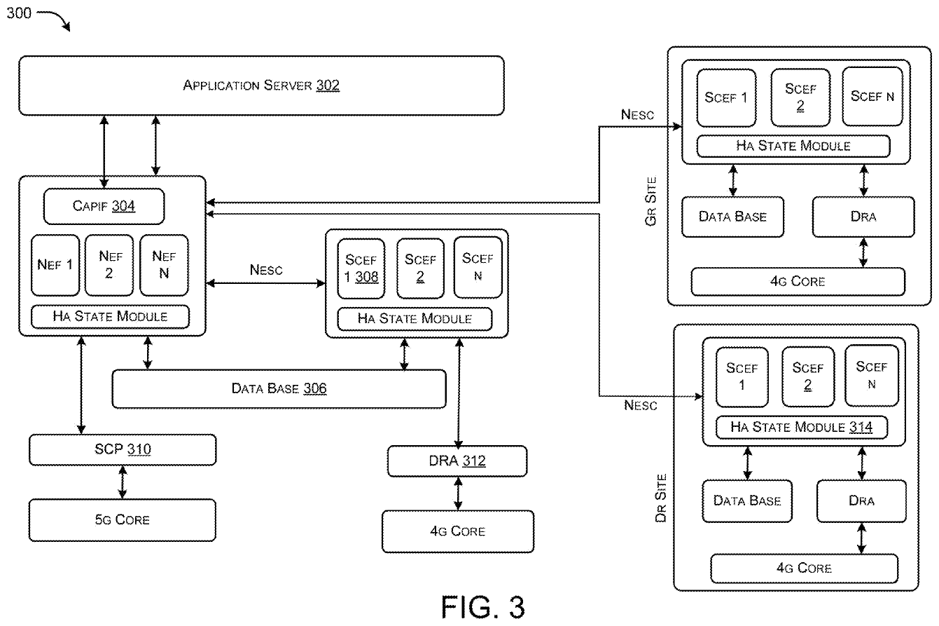

FIG. 3 illustrates an exemplary architecture (300) of the converged NEF system (100), in accordance with an embodiment of the present disclosure.

With respect to FIG. 3, an application server (302) of the converged NEF system (100) interacts with a CAPIF (304) to fetch the OAUTH token, converged NEF instance ID, and protocol. The application server (302) interacts with the converged NEF (using details received from CAPIF (304)) over N33 interface to make requests. The converged NEF saves the data related to requests in a data base (306). The NEF internally forwards the requests to the SCEF (308) at local site, geo-redundant site, and disaster recovery site. The NEF makes subscriptions on 5G nodes via SCP (310). The SCEF (308) makes subscription on 4G nodes. A DRA (312) routes SCEF's diameter requests to the 4G nodes.

In case of occurrence of subscribed event in 4G core, the SCEF (308) reports the event to the converged NEF using the NEF ID received from the NEF. The converged NEF reports this event to the AF and save the event in the data base.

In case event occurs in 5G core, the converged NEF reports the event to the AF and save the event in the data base.

An HA state module (314) is an internal component to manage HA among multiple instances of applications so that at least one instance always remains active.

In an embodiment, for 5GC case, the SCEF initiates new diameter connection towards the IPSM/SMSC having SMSF identities. For EPC case, the SCEF uses existing diameter connection towards the IPSM/SMSC having MME identities.

In an embodiment, for 5GC case, the IPSM/SMSC delivers a device trigger request to the UE via the SMSF. For EPC case, the IPSM/SMSC delivers the device trigger request to the UE via the MME.

In an embodiment, if delivery report is enabled, data buffering may be avoided at the IPSM/SMSC. Then DRR is done for 5GC over new diameter connection likewise for EPC over existing diameter connection.

In an embodiment, if data is getting buffered at the IPSM/SMSC due to UE's non-reachability in 5GC and then user got attached in EPC, then the IPSM/SMSC receives trigger from HSS (over s6c) having MME identity based on which buffered data is delivered over EPC instead of 5GC and vice versa.

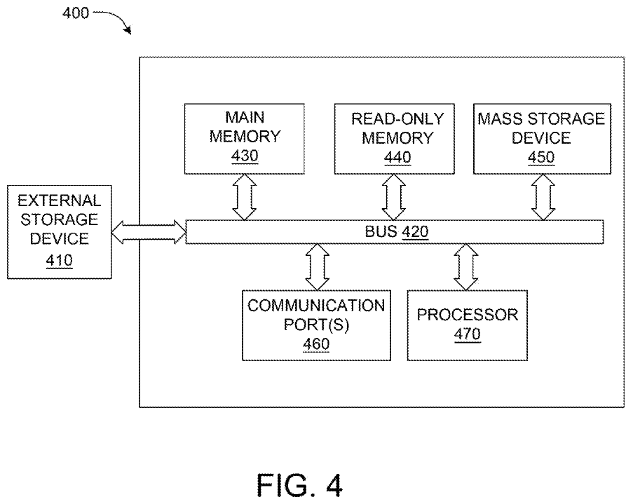

FIG. 4 is an illustration (400) of a non-limiting example of details of computing hardware used in the system (100), in accordance with an embodiment of the present disclosure. As shown in FIG. 4, the system (100) may include an external storage device (410), a bus (420), a main memory (430), a read only memory (440), a mass storage device (450), a communication port (460), and a processor (470). A person skilled in the art will appreciate that the system (100) may include more than one processor (470) and communication ports (460). Processor (470) may include various modules associated with embodiments of the present disclosure.

In an embodiment, the communication port (460) is any of an RS-232 port for use with a modem-based dialup connection, a 10/100 Ethernet port, a Gigabit or 10 Gigabit port using copper or fiber, a serial port, a parallel port, or other existing or future ports. The communication port (460) is chosen depending on a network, such a Local Area Network (LAN), Wide Area Network (WAN), or any network to which the system (100) connects.

In an embodiment, the memory (430) is Random Access Memory (RAM), or any other dynamic storage device commonly known in the art. Read-only memory (440) is any static storage device(s) e.g., but not limited to, a Programmable Read Only Memory (PROM) chips for storing static information e.g., start-up or Basic Input/Output System (BIOS) instructions for the processor (470).

In an embodiment, the mass storage (450) is any current or future mass storage solution, which is used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (420) communicatively couples the processor(s) (470) with the other memory, storage, and communication blocks. The bus (420) is, e.g., a Peripheral Component Interconnect (PCI)/PCI Extended (PCI-X) bus, Small Computer System Interface (SCSI), Universal Serial Bus (USB) or the like, for connecting expansion cards, drives and other subsystems as well as other buses, such a front side bus (FSB), which connects the processor (470) to the system (400).

Optionally, operator and administrative interfaces, e.g., a display, keyboard, joystick, and a cursor control device, may also be coupled to the bus (420) to support direct operator interaction with the system (400). Other operator and administrative interfaces are provided through network connections connected through the communication port (460). Components described above are meant only to exemplify various possibilities. In no way should the aforementioned exemplary illustration (400) limit the scope of the present disclosure.

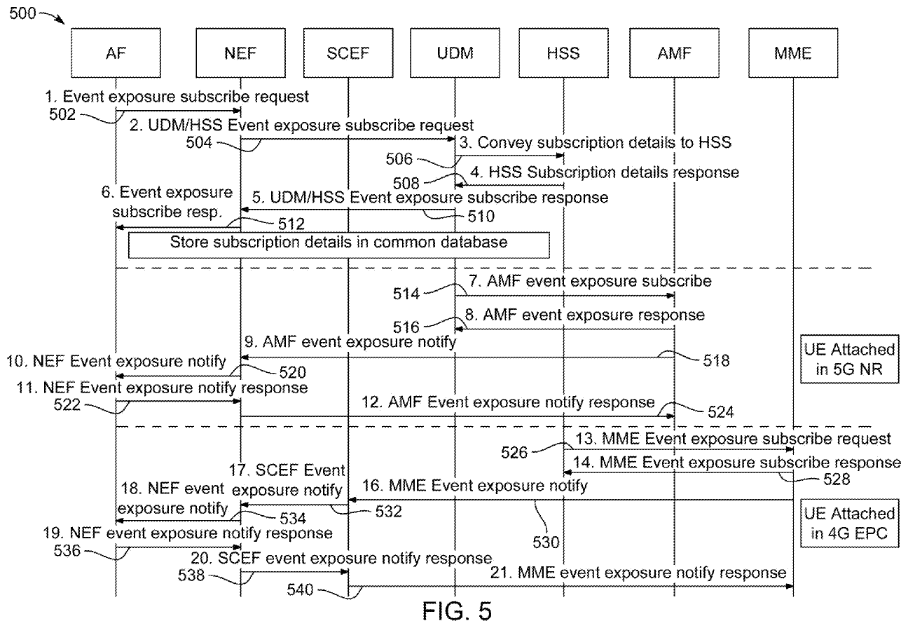

FIG. 5 illustrates an exemplary flow mechanism (500) of creating monitoring event by the system, in accordance with an embodiment of the present disclosure. The monitoring events feature monitors specific events in the 3GPP system and makes monitoring event information available using converged NEF. It identifies the 3GPP network element suitable for configuring specific events, event detection, and event reporting to the authorized users, for example, for use by applications or logging. If such an event is detected, the network can be configured to perform special actions, for example, limit UE access.

The AF subscribes to an event on NEF specifying monitoring Type with maximum Number of Reports and monitor Expire Time. AF will get Converged NEF-ID during on-boarding procedure with CAPIF. At step 502, the AF send an event exposure subscribe request to the NEF.

At step 504, the NEF forwards the received request towards the UDM. After receiving and validating “Event Exposure” request, NEF will subscribe to UDM in nudm_EventExposure_subscribe irrespective of UE is in EPC or 5GC with additional parameters like epcAppliedInd, scefDiamHost, scefDiamRealm, NEF ID etc. NEF will send only one subscription ID along with multiple REF ID for multiple Montes per UE to UDM. So, in case of a new Monte create request, NEF will use same subscription ID and create a reference ID for Monte and send it to UDM-HSS cluster. At step 506, the UDM conveys the received request towards the HSS. UDM will forward this subscription to AMF (based on Monte) with type and maxReports and expiry. AMF/SMF shares it's ID with UDM during UE attached procedure in 5GC in Namf_EventExposure_subscribe. At step 508, the HSS transmits an HSS subscription details response to UDM. If UE attaches in 5G, the UDM-HSS cluster provisions the Monte of AMF as per PDN connectivity request. While, in case UE attaches in 4G, HSS creates Monte on MME based on existing PDN connectivity request. At step 510, the UDM transmits an UDM/HSS event exposure subscribe response to NEF. At step 512, the NEF forwards the response towards the AF.

At step 514, the UDM sends an AMF event exposure subscribe request to the AMF. At step 516, the AMF sends the Monte configuration response to UDM and UDM forwards it NEF (step 518).

At step 520, the NEF transmits the event exposure notify to the AF. The AF send an NEF event exposure notify response to the NEF (step 522).

At step 524, the NEF sends an AMF event exposure notify response to the AMF. The HSS also sends an MME event exposure subscribe request to the MME (STEP 526). At step 528, the MME sends a response towards the HSS. The MME also sends the MME event exposure notification request towards the SCEF (step 530). For EPC, HSS will forward subscription to MME based on MME ID shared to HSS during UE attach procedure. HSS forwards the subscription response to UDM after receiving event subscription response from MME. The UDM forwards event exposure subscription response to NEF.

At step 532, the SCEF forwards the event exposure notification towards the NEF and the NEF send the same towards the AF (step 534). In response, the AF sends an event exposure notify response towards the NEF (step 536). The NEF sends a response towards the SCEF (step 538). At step 540, the SCEF sends a response towards the MME.

In case of Monte Delete request from AF, NEF initiates a PATCH request to update the subscription. The PATCH request contains all existing Monte REF ID, corresponding reporting options etc. except the REF ID of Monte intended to be deleted by AF from NEF to UDM

In case of event detection:

For 5GC, AMF/SMF detects the event based on UE availability and send notification to NEF based on converged NEF-ID received from UDM during subscription. The converged NEF-ID is a callback for forwarding request to Converged NEF clusters of multiple instance. In case of Monte report flow via SCP, converged NEF-ID/Ref ID is visible in binding header.

For EPC, MME detects this event based on UE availability and send notification to SCEF based on converged NEF-ID received from HSS during subscription & further SCEF forwards notification to NEF.

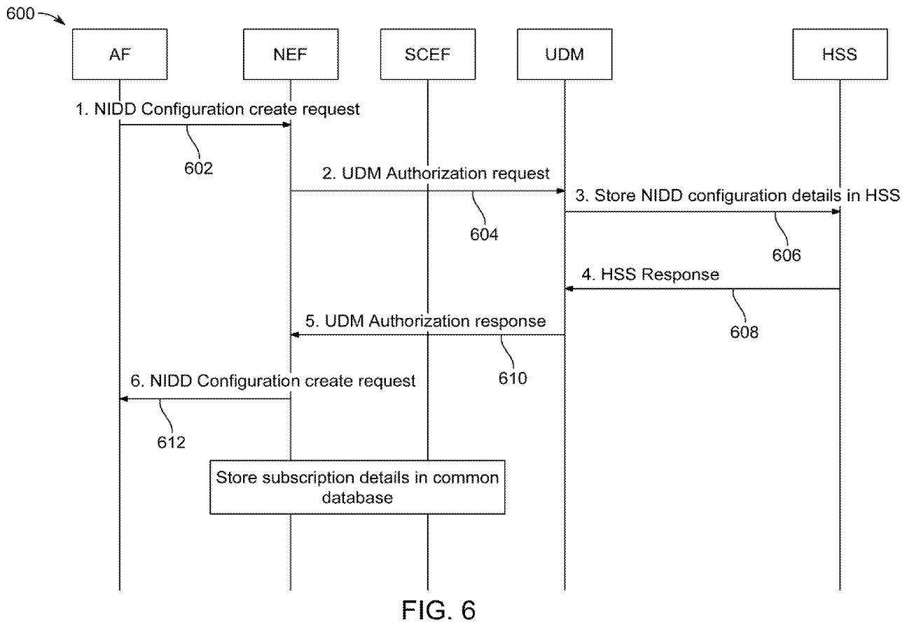

FIG. 6 illustrates an exemplary flow mechanism (600) of non-IP data delivery (NIDD) configuration by the system, in accordance with an embodiment of the present disclosure.

At step 602, the AF initiates a “NIDD Config Create” request towards the converged NEF after getting “converged NEF-ID” from CAPIF procedure. The converged NEF initiates “Nudm_NIDDAuthorisation” request towards UDM for authorization of MSISDN (step 604). The converged NEF also shares converged NEF-ID to UDM.

UDM-HSS cluster has a common database. Hence, NIDD configuration ID, commonly used by HSS and UDM, stored in the HSS (step 606).

At step 608, the HSS sends a response towards the UDM. The SCEF send an UDM authorization response along with NEF ID (step 610). These IDs are used for discovering active SCEF the NEF instance in case of UE attach in 4G EPC and 5G NR respectively. On receiving response from HSS, UDM forwards the authorization response to NEF. The converged NEF-ID and other NIDD config details are stored in a common database accessible by SCEF. At step 612, NEF sends a NIDD configuration create request to the AF. The UDM stores NIDD configuration ID and converged NEF-ID in HSS after authorizing the AF request.

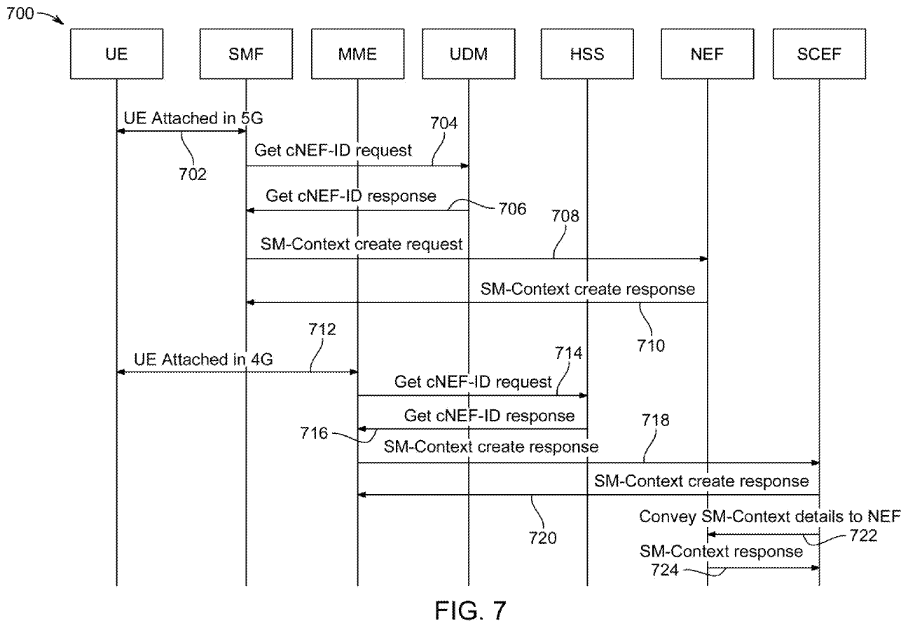

FIG. 7 illustrates an exemplary flow mechanism (700) for session management (SM)-context creation by the system, in accordance with an embodiment of the present disclosure.

The UE attaches in 5GCN with PDU session type as “UNSTRUCTURED” and NEF ID in subscription information of PDN request (step 702). If UE request contains NEF ID, the SMF initiates SMF-NEF connection establishment procedure to corresponding converged NEF instance or else SMF fetches the NEF-ID from UDM (Nudm_UECM_Get service operation containing NF ID, UE ID). At step 704, the SMF sends a cNEF-ID request to the UDM, and the UDM reverts with a response towards the SMF (step 706). At step 708, the SMF sends a SM-context create request to the NEF, and the NEF reverts with a response towards the SMF (step 710). SMF sends SM-Context create request towards Converged NEF using “Nnef_SMContext_Create Request” (User Identity, PDU session ID, NIDD information, S-NSSAI, DNN). The NEF creates an NEF PDU session Context and associates it with User Identity and PDU session ID. The NEF invokes Nnef_SMContext_Create Request Response.

In case UE attaches in 4G EPC, MME fetches SCEF ID either from UE PDN connectivity request or from HSS and initiates SM-Context create request with SCEF in Converged NEF cluster. The SCEF forwards the SM context create request to NEF internally over NeSC interface. The SM-context will help NEF to forward MT messages to correct SCEF. At step 712, the UE is attached with the MME. At step 714, the SMF sends a cNEF-ID request to the HSS, and the HSS reverts with a response towards the MME (step 716). At step 718, the MME sends a SM-context create request to the SCEF, and the SCEF reverts with a response towards the MME (step 710). At step 722, SCEF sends SM-context details towards the NEF and the NEF sends a response towards the SCEF (step 724).

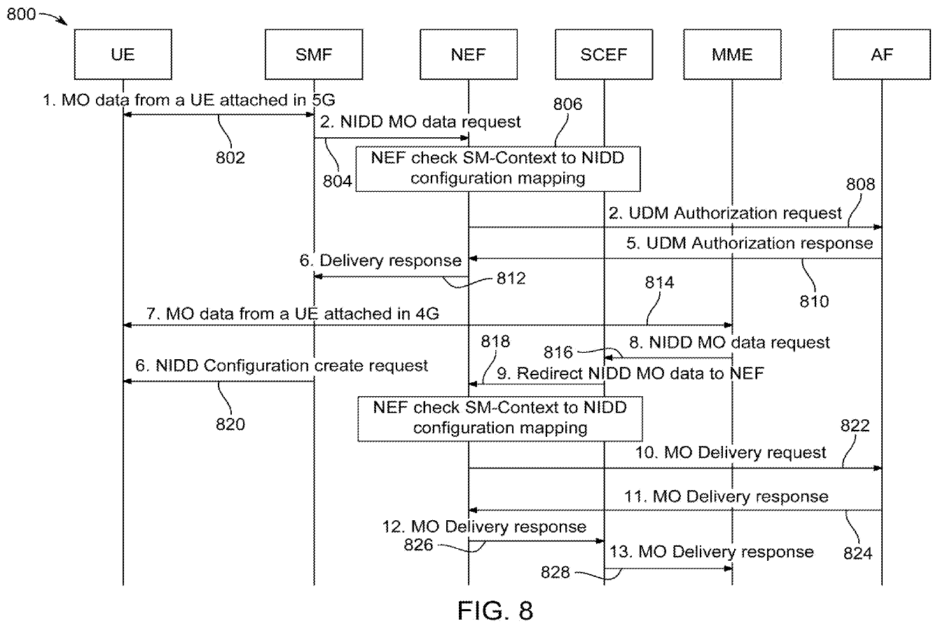

FIG. 8 illustrates an exemplary flow mechanism (800) for mobile originated messages (MO)-context creation by the system, in accordance with an embodiment of the present disclosure.

In Case MO received from 5GC attached UE (step 802), SMF forwards the MO in “NIDD_submit_request” towards NEF based on SM-context (step 804).

The NEF checks SM-context and NIDD mapping to search AF endpoint (step 806) and forwards the message (authorization request) to AF (step 808). At step 810, the AF forwards a response to the NEF. The NEF forwards a delivery response to SMF (step 812). In an example, the NEF forwards the delivery response to UE as per RDS support and configuration in NIDD configuration.

In Case MO received from EPC user (step 814), MME forwards the MO message to SCEF based on SM-context (step 816). Further SCEF forwards MO to NEF over NeSC interface (step 818) to deliver it to AF. The NEF will check SM-context and NIDD mapping to search AF endpoint and will forward the message to AF.

At step 820, SMF sends a NIDD configuration create request to the UE. At step 822, NEF sends a MO delivery request to AF and the AF reverts with a response (step 824). The NEF sends the MO delivery response to the SCEF (step 826). At step 826, SCEF forwards the response to the MME.

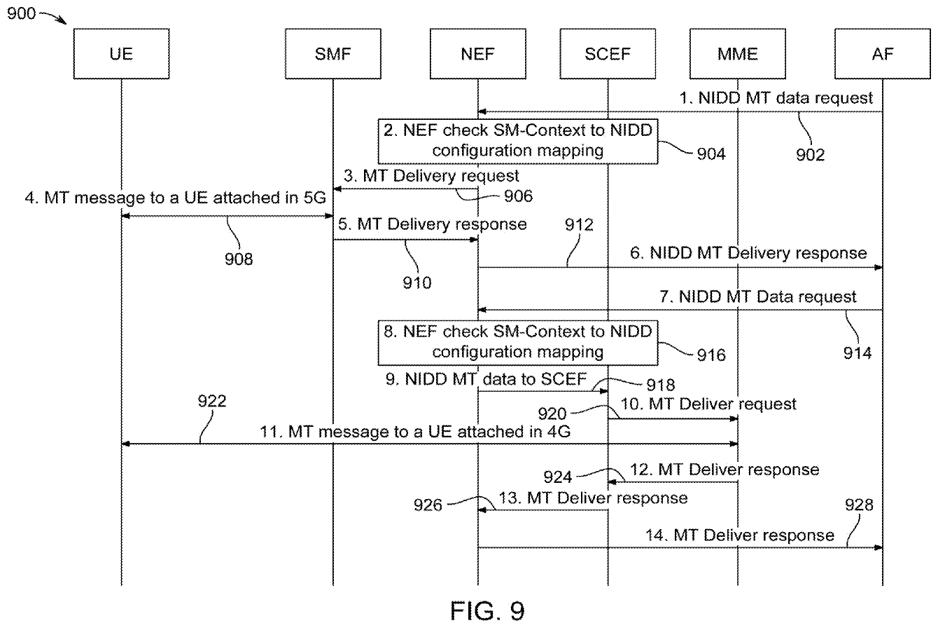

FIG. 9 illustrates an exemplary flow mechanism (900) for mobile terminate message (MT)-context creation by the system, in accordance with an embodiment of the present disclosure.

At step 902, the AF sends NIDD MT data request. For MT delivery to 5GC UE: NEF checks NIDD-configuration and SM-context mapping (step 904). Based on that NEF forwards MT delivery to SMF (step 906). At step 908, the SMF sends a MT message to a UE attached in 5G. The SMF sends a MT delivery response to the NEF (at step 910). At step 912, the NEF sends a NIDD MT delivery response to the AF. NEF checks NIDD-configuration and SM-context mapping (step 916). At step 918, the NEF sends NIDD MT data to SCEF. Further, the SCEF sends a MT delivery request to the MME (step 920). During step 922, the MT message is exchanged between the UE and the MME attached in 4G. For MT delivery to EPC UE: NEF checks SM-context and forward MT message to SCEF (step 924). Further SCEF checks mapping of NIDD-config and SM-context for MME identity and then it forwards MT delivery to MME for delivery to UE. At step 926, the SCEF forwards a MT delivery response to the NEF. At step 928, the NEF sends the MT delivery response to the AF.

MT buffering at SCEF+NEF (interworking unit):
(a) MT buffered at NEF & UE moved from EPC to 5GC: In this case new SM-context comes to NEF from SMF which overwrite the previous SM-context received from MME/SCEF. Further, NEF sends a delete trigger to SCEF for SM-context deletion received previously from MME. Based on new context from SMF, NEF initiates buffered MT delivery to SMF towards UE.
(b) MT buffered at NEF & UE moved from 5GC to EPC: In this case new SM-context comes to SCEF from MME. NEF overwrites new SM-context with previous SM-context received from SMF. NEF initiates buffered MT delivery to SCEF.

The SCEF initiates MT delivery to MME towards UE. The SCEF sends the delivery response to NEF.

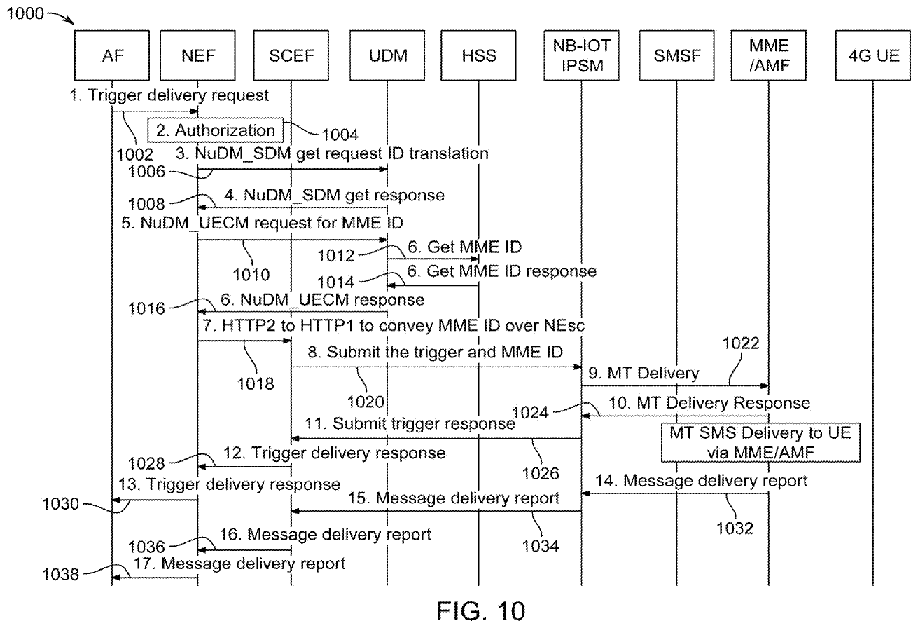

FIG. 10 illustrates an exemplary flow mechanism (1000) for device triggering by the system, in accordance with an embodiment of the present disclosure.

At step 1002, AF subscribes for DT with triggerPayload based on SCEF+NEF-ID received while CAPIF onboarding process. At step 1004, NEF performs authorization of the received request. NEF queries Nudm_UECM_Get to retrieve the UE SMSF identities over 5GC delivery (step 1006) or MME identities over EPC delivery (step 1010). At step 1008, the UDM sends a response to the NEF. UDM queries HSS internally to fetch MME identity (step 1012). The Nudm_UECM request has “NF Type” header containing “NEF” as its value. On receiving this type of “Nudm_UECM request”, UDM shall return SMSF ID in case of 5G UE attach or MME ID in case of 4g UE attach as optional parameter in response. NEF forwards SMSF ID or MME ID to SCEF over NeSC interface. At step 1014, the HSS sends MME ID response to the UDM. Then the UDM forwards the response to the NEF (step 1016).

NEF sends subscription over http2 to ELB which further translated to http1 towards SCEF (step 1018). This implementation is to avoid diameter interface over NEF as its already available on SCEF toward IPSM/SMSC. NEF sends SMSF identity to SCEF for 5GC case and optionally MME identity for EPC case5) SCEF to IPSM/SMSC over diameter. For 5GC case SCEF initiates new diameter connection towards IPSM/SMSC having SMSF identities. For EPC case SCEF uses existing diameter connection towards IPSM/SMSC having MME identities.

At step 1020, the SCEF submits the trigger and the MME ID to the IPSM. For 5GC case IPSM/SMSC delivers MT delivery request to MME/AMF (step 1022). At step 1024, the MME/AMF replies back with a response. The IPSM submits the trigger response to the SCEF (step 1026). For EPC case IPSM/SMSC delivers DT request to UE via MME.

At step 1028, the SCEF sends a response towards the NEF. Further the NEF sends a response to the AF (step 1030). Also, the MME/AMF sends a delivery report to the IPSM (step 1032). Then the IPSM sends the delivery report to the SCEF (step 1034). The SCEF sends the delivery report to the NEF (step 1036). the NEF sends the delivery report to the AF (step 1038).

If delivery report is enabled, then no data buffering at IPSM/SMSC. Then DRR is done for 5GC over new diameter connection likewise for EPC over existing diameter connection. If data is getting buffered at IPSM/SMSC due to UE's non-reachability in 5GC and then user got attached in EPC, then IPSM/SMSC receives trigger from HSS (over s6c) having MME identity based on which buffered data will be delivered over EPC instead of 5GC and vice versa.

The present disclosure is configured to provide a system (100) and a method for providing smoothing communication to a user equipment in a network. In the context of 5G, user equipment refers to the devices used by end-users, such as smartphones, tablets, IoT devices, and other connected gadgets. The system (100) alleviates one or more issues related to smoothing communication both UE devices and other network elements within 5G networks. These issues could encompass challenges such as latency, reliability, efficiency, or other concerns that may arise during the process of triggering. The system (100) may be placed within a 5G communication network (used in IoT core) that may involve various algorithms, protocols, or mechanisms to enhance the efficiency and reliability of events, ensuring a smoother operation of user equipment and network elements in 5G networks.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While the foregoing describes various embodiments of the present disclosure, other and further embodiments of the present disclosure may be devised without departing from the basic scope thereof. The scope of the present disclosure is determined by the claims that follow. The present disclosure is not limited to the described embodiments, versions, or examples, which are included to enable a person having ordinary skill in the art to make and use the present disclosure when combined with information and knowledge available to the person having ordinary skill in the art.

### ADVANTAGES OF THE PRESENT DISCLOSURE

The present disclosure handles Evolved Packet Core (EPC) and 5G Core (5GC) interworking for network exposure scenarios.

The present disclosure exposes network capabilities and User Equipment (UE) related information to external Application Functions (AFs) and to internal Network Functions (NFs) (like Network Data Analytics Function (NWDAF)).

The present disclosure supports monitoring of event exposure of the NFs and expose the events of the NFs to the AF.

The present disclosure supports device triggering.

The present disclosure supports Non-IP Data Delivery (NIDD) configuration.

The present disclosure supports Mobile Originated (MO), Mobile Terminated (MT), and Session Management (SM)-Context creation.

The present disclosure provides an interface for communication between Network Exposure Function (NEF) and Service Capability Exposure Function (SCEF) while aggregating data from 4G and 5G network.

The present disclosure reduces NEF/SCEF dependency on Access and Mobility Function (AMF) and Mobility Management Entity (MME) communication for interworking scenarios using the interface.

We claim:

1. A system (100) for handling interworking communication between an Evolved Packet Core (EPC) and a 5G Core (5GC), said system (100) comprising:
a receiving node (150) configured to generate at least one request for fetching at least one network related information and at least one user equipment related information from said EPC and said 5GC; and
an interworking node (170) coupled to said receiving node (150) to receive said generated at least one request from said receiving node, said interworking node includes a network exposure function (NEF) and a service capability exposure function (SCEF), said interworking node is configured to:
process said received request;
connect said receiving node to a specific network element; and
enable at least one service in said EPC and said 5GC.

2. The system (100) as claimed in claim 1, further includes a NEF application (102), a NEF database (DB) (104), a common application programming interface framework (CAPIF) (106), a NEF manager (108), an elastic load balancer (ELB) (110), a SCEF application (112), a SCEF-supplementary downlink (SDL) (114), a SCEF-ELB (116), and a SCEF-operations, administration, and maintenance (OAM) (118).

3. The system (100) as claimed in claim 1, wherein said receiving node is an application function (AF), an application server (AS), and a network function.

4. The system (100) as claimed in claim 1, wherein said NEF and said SCEF are connected via a NeSC interface.

5. The system (100) as claimed in claim 4, wherein said NeSc interface is configured to employ a second version of the Hypertext Transfer Protocol (HTTP2) protocol.

6. The system (100) as claimed in claim 4, wherein said NeSc interface is configured to provide a point of contact to said receiving node irrespective of user equipment being in said EPC or said 5GC.

7. The system (100) as claimed in claim 1, wherein said at least one service is selected from a group consisting of monitoring of event, device triggering, non-IP data delivery (NIDD) configuration, mobile originated messages (MO)-context creation, mobile terminate message (MT)-context creation, and session management (SM)-context creation.

8. The system (100) as claimed in claim 1, wherein said specific network element is selected from a group consisting of access and mobility management function (AMF), session management function (SMF), unified data management (UDM), binding support function (BSF), network data analytics function (NWDAF), mobility management entity (MME), home subscriber server (HSS), policy and charging rules function (PCRF), short message service center (SMSC), service control point (SCP), SMS function (SMSF), IP short message (IPSM), SMS service center (SMS-SC).

9. The system (100) as claimed in claim 2, wherein said NEF manager (108) is configured to communicate with an element management system (EMS) that provides performance management, fault management, backup, and restoration of configuration.

10. The system (100) as claimed in claim 2, wherein said NEF database (DB) (104) includes 3 master databases, 3 slave databases, and 1 replication database.

11. A method for handling interworking communication between an Evolved Packet Core (EPC) and a 5G Core (5GC), said method comprising:
receiving, by an interworking node, a request from a receiving node, wherein said interworking node includes a network exposure function (NEF) and a service capability exposure function (SCEF);
processing, by said interworking node, said received request;
connecting, by said interworking node, said receiving node to a specific network element; and
enabling, by said interworking node, at least one service in said EPC and said 5GC.

12. The method as claimed in claim 11, wherein said receiving node is an application function (AF), an application server (AS), and a network function.

13. The method as claimed in claim 11, wherein said specific network element is selected from a group consisting of access and mobility management function (AMF), session management function (SMF), unified data management (UDM), binding support function (BSF), network data analytics function (NWDAF), mobility management entity (MME), home subscriber server (HSS), policy and charging rules function (PCRF), short message service center (SMSC), service control point (SCP), SMS function (SMSF), IP short message (IPSM), SMS service center (SMS-SC).

14. The method as claimed in claim 11, wherein said interworking node is configured to aggregate data from a 4G network and a 5G network.

15. The method as claimed in claim 11, wherein said at least one service is selected from a group consisting of monitoring of event, device triggering, non-IP data delivery (NIDD) configuration, mobile originated messages (MO)-context creation, mobile terminate message (MT)-context creation, and session management (SM)-context creation.

16. A converged network exposure function (NEF) (208) for handling interworking communication between an Evolved Packet Core (EPC) and a 5G Core (5GC), said converged network exposure function (NEF) comprising:
a network exposure function (NEF);
a service capability exposure function (SCEF); and
in a processing unit configured to:
receive at least one request from an application function (AF) for fetching at least one network related information and at least one user equipment related information from said EPC and said 5GC;
process said received request;
connect said receiving node to a specific network element; and
enable at least one service in said EPC and said 5GC.

17. The converged network exposure function (NEF) (208) as claimed in claim 16, wherein said NEF and said SCEF are connected via a NeSC interface.

18. The converged network exposure function (NEF) (208) as claimed in claim 16, wherein said NeSc interface is configured to employ a second version of the Hypertext Transfer Protocol (HTTP2) protocol.

19. The converged network exposure function (NEF) (208) as claimed in claim 16, wherein said NeSc interface is configured to provide a point of contact to said receiving node irrespective of user equipment being in said EPC or said 5GC.

20. A computer program product comprising a non-transitory computer-readable medium comprising instructions that, when executed by one or more processors, cause the one or more processors to execute a method for handling interworking communication between an Evolved Packet Core (EPC) and a 5G Core (5GC), the method comprising:
receive, by an interworking node, at least one request from a receiving node, wherein said interworking node includes a network exposure function (NEF) and a service capability exposure function (SCEF);
process, by said interworking node, said received request;
connect, by said interworking node, said user equipment to a specific network element; and
enable, by said interworking node, at least one service in said EPC and said 5GC.
